(19) United States
(12) Patent Application Publication
(10) Pub. No.: US 2004/0161732 A1
(43) Pub. Date: Aug. 19, 2004

(54) Medical teaching resource and play product for children with chronic illnesses

(76) Inventors: Ronda G. Stump, Elizabethtown, PA (US); Lisa A. Gotshall-Van Lare, Phoenix, AZ (US); Daniel E. Van Lare, Phoenix, AZ (US)

Correspondence Address: REED SMITH LLP, 2500 ONE LIBERTY PLACE, 1650 MARKET STREET, PHILADELPHIA, PA, 19103, US

(21) Appl. No.: 10/779,312

(22) Filed: Feb. 12, 2004

Related U.S. Application Data
(63) Continuation of application No. 10/100,725, filed on Mar. 19, 2002, now abandoned.
(60) Provisional application No. 60/277,769, filed on Mar. 22, 2001.

(51) Int. Cl. G09B 23/28

(52) U.S. Cl. 434/262

(57) ABSTRACT

An educational toy in the form of an interactive microprocessor-controlled doll and associated pseudo-medical equipment are provided for educating chronically ill children about illness treatment and management. A kit containing the doll, equipment, a story book, and a carrying case is also provided. The toy of the present invention can be used by children, parents, and medical caregivers in doctor's offices, hospitals, homes, and clinics to teach the user about treatment and management one or more chronic illnesses, including but not limited to asthma, cystic fibrosis, allergies, and diabetes.

### CROSS-REFERENCE TO RELATED APPLICATIONS

This application is a continuation of U.S. patent application Ser. No. 10/100,725 entitled “MEDICAL TEACHING RESOURCE AND PLAY PRODUCT FOR CHILDREN WITH CHRONIC ILLNESSES,” filed on Mar. 19, 2002, the entire disclosure of which is hereby incorporated by reference herein.

### FIELD OF THE INVENTION

The present invention relates generally to educational toys. More particularly, the invention relates to a toy for educating users, such as caregivers, children, and parents concerning the treatment and management of childhood chronic illnesses including but not limited to asthma, allergies, cystic fibrosis, and diabetes. This invention also relates to an associated kit.

### BACKGROUND OF THE INVENTION

Asthma is a reversible obstructive lung disease, caused by an increased reaction of the airways to various stimuli. Asthma is characterized by excessive sensitivity of the lungs to various stimuli or “triggers”. Each person afflicted with asthma may react to different triggers. It is a chronic condition with life-threatening consequences if not properly managed. According to the American Lung Association, asthma is the leading serious chronic childhood illness, affecting approximately 8.6 million children in the United States under 18 years of age. Pediatric asthma has an enormous economic toll in the United States, resulting in nearly $1 billion in lost productivity cost, and a direct treatment cost approaching $2 billion. Even though asthma cannot be cured at this time, it can very often be controlled through appropriate medical treatment and patient management. As appropriate to their age and developmental level, children should be included in disease self-management. They should understand what is happening to their body and how the treatment plan helps keep them well.

Allergic disorders rank first among children's childhood diseases. They are quite common in children. An estimated 40-45 million Americans have some kind of allergy, with most allergies first appearing in childhood. Allergies can show up in different ways in children. Skin rashes, asthma, and allergic rhinitis (the most common of all allergy problems) are some common forms. Many childhood problems are exacerbated by allergies. Allergies are the most common cause of chronic nasal congestion in children. Some allergies (not most) can be fatal. In such cases, education and knowledgeable self-management skills are vital. Early identification and routine treatment will improve quality of life, reduce missed school days and parent work days.

Cystic Fibrosis is a genetic disease affecting approximately 30,000 children and adults in the United States. Cystic Fibrosis (“CF”) causes the body to produce an abnormally thick, sticky mucus, due to the faulty transport of sodium and chloride salt within cell lining organs such as the lungs and pancreas, to their outer surfaces. The thick CF mucus also obstructs the pancreas, preventing enzymes from reaching the intestines to help break down and digest food. CF has a variety of symptoms including very salty-tasting skin, persistent coughing, wheezing, excessive appetite but poor weight gain, and bulky stools. The treatment of cystic fibrosis depends upon the stage of the disease and organs involved. Some of the equipment used to manage asthma is also used in cystic fibrosis treatment. Cystic Fibrosis is an incurable condition, but its symptoms can help be controlled through appropriate medical treatment and patient management. Cystic fibrosis, too, is a costly disease, but good management can help reduce some of the costs, particularly hospitalization. The potential market for an effective treatment of the associated lung infections is reported to be over $300 million in the United States alone. Children should be involved in their own disease self-management. Involvement includes an understanding of the disease and an active role in their own treatment and management, as appropriate to their age and developmental level.

Juvenile Diabetes (Type I) affects more than one million Americans, with 13,000 new children being diagnosed each year. Type 1 diabetes often strikes children suddenly, making them insulin-dependent for life. It can strike adults, but children are more commonly diagnosed with the chronic disease. In Type 1 diabetes an individual's pancreas produces little or no insulin. Insulin is a hormone that is needed to allow the cells in the body to use the energy provided by the foods we eat. Individuals, particularly children, with Type 1 diabetes need constant care and daily monitoring. Type 1 diabetics must take daily glucose readings and perform insulin injections several times a day. It is a very difficult chronic condition to manage. Many factors affect insulin levels needed including diet, exercise, medications, and illness. Type 1 diabetes has a variety of symptoms including extreme thirst, drowsiness, increased appetite, fruity odor in breath, sudden vision changes, and labored breathing. In 1997, the total economic cost of diabetes was estimated to be $98 billion, which includes $44 billion in direct medical and treatment costs and $54 billion for indirect costs. Like asthma and cystic fibrosis above, diabetes can not be cured at this time. However, proper management of the disease allows children to lead as normal lives as possible, while living with a chronic health condition.

The better that children and parents understand chronic illnesses such as asthma, allergies, cystic fibrosis, and diabetes and their associated treatments, the better the child's condition can be managed. Parents and children with a more complete understanding of the chronic illness are better prepared to manage the illness on a daily basis, and are therefore more likely to reduce unwanted medical crises resulting from the illness. Indeed, patient education is an essential component of successful chronic disease management, according to the American Academy of Pediatrics. Patient education is the mechanism through which patients learn to successfully accomplish chronic illness management tasks. As appropriate, young children should be taught to be active participants in the treatment and management of their chronic illnesses, and should be considered equal members of the management team.

Presently, a nurse practitioner or physician in an outpatient setting provides illness management education for newly diagnosed children. A chronic illness diagnosis can be a frightening situation for children and parents, and even in the best of situations, using currently available teaching tools, children and parents can be overwhelmed with an abundance of new medical information in a very short period of time. Studies have shown that medical experiences for young children are less frightening if introduced through play. Additionally, if children are at ease with the situation, parents are more able to concentrate and digest the information. By providing a comfortable, non-threatening, learning environment. the possibility for more successful retention of relevant information by parent and child is extended. The acquisition of relevant knowledge should therefore occur in a comfortable setting using a process adapted to young children, such as medical play. The challenge is to educate young children in a manner that is age-appropriate and appropriate for each individual child's case.

New research also supports patient education as a means to increased adherence to prescribed medical treatment plans. Further, this research notes higher levels of retention, adherence to treatment plans, and the outcomes desired by patient and physician, when the patient health education for children is presented in an interactive, technological format.

Thus, there exists a continuing need in the art for an improved instructional and educational resource, which is relevant to childhood chronic illnesses.

### SUMMARY OF THE INVENTION

The present invention provides an interactive toy for use by a child learning about chronic illnesses. The toy, which may be in the shape of a doll has at least one internal proximity switch disposed at various locations inside the doll. Also present inside the toy are one or more internal electrical wires connecting the proximity switch to an internal microprocessor. Still further included in the toy is an audio speaker connected to the internal microprocessor, wherein, upon activation of the microprocessor, said doll is capable of producing audible sound from the audio speaker. The inventive toy is capable of producing coughing and/or wheezing sounds.

The inventive toy may also be present in combination with an item of pseudo-medical equipment. The pseudo-medical equipment has an activator which triggers a sensor when brought into close proximity with the toy. When the pseudo-medical equipment is brought into close proximity with the toy, and the sensor is triggered, an internal electrical circuit is completed and a signal is sent to the internal microprocessor. In one preferred embodiment, the activators are permanent magnets that trigger proximity switches, and microchips which passively couple to a radio frequency (RF) sensing system. The pseudo-medical equipment may be in the form of any item normally used in the treatment of the illness such as a stethoscope, a peak flow meter, an inhaler, a nebulizer having a medicine-dispensing unit, which are used with regularity in the treatment of asthma, or other illness-related pseudo-medical item. Any of a variety of additional types of switches and triggers may be selected by those skilled in the art. Some pseudo-medical equipment items may contain only one activator, while others may contain more, such as an inhaler which, in one embodiment, is recognized via a body cavity RF sensing system, and also by a proximity switch located in the doll's mouth. Detection at a different location of the doll's body causes a different reaction from the doll.

Still further included in the inventive toy is at least one contact sensor located beneath the outer covering of the toy and disposed at various locations of the body of the toy. The contact sensor is connected to the internal microprocessor by electrical wires. When depressed, a completed circuit causes a response, or series of response from the doll. In one embodiment, depressing the hand, which contains such a sensor, causes the doll to produce a coughing sound.

The invention as described herein contains numerous types of sensor and trigger systems. In one embodiment, a RF sensor resides in the doll's body cavity and is triggered when the equipment comes in close proximity with a passively activated microchip located in each item of pseudo-medical equipment. In one embodiment a contact sensor in one hand of the doll is triggered by depression of the doll's hand, forcing two metal plates to make contact. A plurality of magnetic switches are located at various positions within the doll's body, such as in the mouth, and the torso, and are triggered by close proximity to pseudo-medical equipment items that contain permanent magnets. In any embodiment, each activated sensor/trigger feeds a unique signal to the microprocessor to trigger a distinct audible response from the doll.

Also included in the present invention is a kit suitable for use by a child, which kit includes the inventive toy, at least one item of pseudo-medical equipment, and a knapsack for storing and carrying the doll and pseudo-medical equipment. The kit may also include a book, wherein the words of the book are programmed into the inventive toy, and wherein upon activation of the toy, audible sounds are produced which correspond to the words of the book.

### BRIEF DESCRIPTION OF THE DRAWINGS

FIG. 1A is a front view of the female clothed doll in accordance with one embodiment of the present invention.

FIG. 1B is a back view of the female clothed doll in accordance with the present invention.

FIG. 1C is a side view of the female clothed doll in accordance with the present invention.

FIG. 2A is a front view of the male clothed doll in accordance with the present invention.

FIG. 2B is a back view of the male clothed doll in accordance with the present invention.

FIG. 2C is a side view of the male clothed doll in accordance with the present invention.

FIG. 3 is a close-up front facial view of the female and male doll in accordance with the present invention. The facial views are also included as facial pictures on the patient chart in accordance with the present invention.

FIG. 4 is a front cut-away view of the female doll in accordance with the present invention without clothing, showing locations of internal sensors in accordance with the asthma version of the present invention.

FIG. 5 is a perspective cut-away view of the doll hand of the present invention showing one embodiment of a sensor comprising a metal-to-metal connector for identification of various pseudo-medical objects.

FIG. 6 is a rear cut-away view of the female doll in accordance with the asthma version of the present invention without clothes, showing locations of the internal sensors and proximity switches, the master switch, play switch, communications port, and battery access panel in accordance with the present invention.

FIG. 7 is a cross sectional side view of the torso of the doll in accordance with the asthma version of the present invention, showing the doll's internal electronic circuitry, sensors and proximity switches, speakers, microprocessor, and internal power source, among other things.

FIG. 8 is a schematic of the doll's internal electronic circuitry in accordance with the asthma version of the present invention.

FIG. 9B is a close up detail of the doll's mouth in accordance with the asthma version of the present invention.

FIG. 9A is a cross-sectional side view of the doll's mouth in accordance with the asthma version of the present invention.

FIG. 10 is a perspective view of the pseudo-medical equipment nebulizer in accordance with the asthma and cystic fibrosis versions of the present invention.

FIG. 11 is a perspective view of the compressed air nebulizer in accordance with the present invention.

FIG. 12 is a front view of the peak flow meter in accordance with the asthma version of the present invention.

FIG. 13 is a cross sectional view of the peak flow meter in accordance with the asthma version of the present invention.

FIG. 14 is a front view of the inhaler in accordance with the asthma and Cystic Fibrosis versions of the present invention.

FIG. 15 is a cross section view of the inhaler in accordance with the asthma and Cystic Fibrosis versions of the present invention.

FIG. 16 is a perspective view of the medicine dropper bottle in accordance with the asthma version of the present invention.

FIG. 17 is a front elevation view of the mask in accordance with the asthma and Cystic Fibrosis versions of the present invention.

FIG. 18 is a side cross-sectional view of the mask in accordance with the asthma and Cystic Fibrosis versions of the present invention.

FIG. 19B is a front elevation view of a patient chart in accordance with the present invention.

FIG. 19A is a front close-up view of the facial pictures included on the patient chart in accordance with the present invention.

FIG. 20B is a perspective view of the book in accordance with the present invention.

FIG. 20A is a perspective view of the doll holding the book in accordance with the present invention.

FIG. 21 is a front elevation view of the stethoscope in accordance with the present invention.

FIG. 22 is a perspective view of a nose sprayer in accordance with the asthma and allergy versions of the present invention.

FIG. 23 is a perspective view of the medical identification bracelet in accordance with the present invention.

FIG. 24 is a perspective view of the syringe in accordance with the asthma version of the present invention.

FIG. 25 is a perspective view of the knapsack in accordance with the present invention.

FIG. 26 is a perspective view of the glucose monitor in accordance with the diabetes version of the present invention.

FIG. 27 is a perspective view of the blood pressure cuff in accordance with the diabetes version of the present invention.

FIG. 28 is a perspective view of the diabetes lancet in accordance with the diabetes version of the present invention.

FIG. 29 is a perspective view of the insulin vial in accordance with the diabetes version of the present invention.

FIG. 30 is a perspective view of the cystic fibrosis vest in accordance with the cystic fibrosis version of the present invention.

### DETAILED DESCRIPTION Of THE INVENTION

The present invention provides an interactive microprocessor-controlled doll, pseudo-medical equipment, and book. The primary use of the invention is for education of caregivers, children, and parents in various settings including hospitals, clinics, doctor offices, schools, day care settings and patient homes. The users can be educated on chronic illness management through play with the invention. For example, a nurse practitioner or other health care professional can use the invention to educate a chronically ill child about the equipment, medicines, triggers, treatments and warning signs of a particular illness. The doll can receive medical treatment from the child using the pseudo-medical equipment, possibly at the same time the child is receiving treatment from a medical professional, caregiver, or parent. The invention can also be used in the home or school setting of a chronically ill child to reinforce the child's treatment plan, and to introduce new information or procedures relative to the child's illness.

The doll of the invention has an internal programmable microprocessor and software which can receive and process electronic signals and execute programmed commands to activate audio recordings stored on a voice chip or other suitable media, simulating physiological sounds or a child's voice. The doll further provides strategically placed sensors and switches that can be activated in response to a child's touch or the use of pseudo-medical equipment. As further described herein, the invention may have various levels of programming capability, including adding a doll's name, the child's name, times of treatment, and specific triggers, among other things. Using external sources, including but not limited to personal computers (PC) and keypads linked to communications ports provided on the doll, users can easily program or modify the doll's microprocessor controlled software to meet the needs of the ill child, and to reflect the teaching environment. The invention can be used in connection with one or more illness-related children's books, which can be read by the doll through activation of software programs using the microprocessor.

The pseudo-medical equipment of the invention includes doll and/or child-sized equipment, which simulate real medical equipment used in the treatment and management of a particular chronic disease. In the case of asthma and allergies, the pseudo-medical equipment may comprise a nebulizer, peak flow meter, peak flow chart, inhaler, medicine dropper bottle, nasal sprayer, stethoscope, syringe, mask, eye dropper and a standard pill-dispensing medication bottle. For Cystic Fibrosis, the kit comprises a pill bottle for vitamins and enzymes, chest vest, PICC line and/or Central line commonly used for medications and frequent blood work, gastronomy tube used for feeding, and a nebulizer, mask, and inhaler (as in the asthma version of the doll). The Diabetes kit comprises include a glucose monitor, insulin pump, lancet with test strips, patient recording chart, insulin syringe, insulin vial, eye chart, blood pressure cuff, and a sick day plan. An insulin pen, insulin pump, medical waste container and other related equipment may also be included in the diabetes version. Preferred embodiments of the doll include a toy medical alert bracelet and an illness-specific story book. The pseudo-medical equipment preferably contains moving parts and electronic features to simulate real medical equipment. It is understood that the kits and items of pseudo-medical equipment appear in numerous embodiments, and combinations can be selected based on need, cost, and consumer preference for example.

In another embodiment, the present invention comprises a kit containing the interactive doll, pseudo-medical equipment, book, and a carrying case. The kit is designed to be appealing to children, and is easy to open, unpack, re-pack, carry, and hold. A carrying case may be provided in the kit. The carrying case is preferably in the form of a knapsack with carrying straps and pockets.

It is to be understood that both the foregoing general description and the following detailed description are exemplary, but are not restrictive, of the invention. Similar toy medical kits may be created for any childhood illness. In addition, the look of various pieces of the equipment may be altered to resemble any true medical equipment. For example, there are many styles of inhalers in use; the kit may include more than one style; the style most widely used; or a style that is most economically feasible to manufacture.

The internal electronics of the doll are designed to be compatible for quick adaptation of the same doll to various illnesses. The number of sensors, the sensor locations, and the recorded audio responses can be changed to adapt to a new illness. Different pseudo-medical equipment can also be provided for an alternate disease doll. It should be understood that the interaction of the toy medical equipment with the doll and the responses the doll provides to the individual equipment pieces are variable to enhance the learning experience. The doll and equipment work together to help create a learning environment for the child that resembles the child's real life treatments for the illness. The doll's ability to recognize each piece of equipment when it is in close proximity, and to respond specifically to that equipment with a medically appropriate phrase, is part of the valuable learning experience. In addition to the illnesses described herein, there are many additional chronic illnesses with additional symptoms and treatment equipment. As necessary, functions may be added to the doll which may include, but not be limited to the ability to change skin or eye color, movement of the chest to correspond to breathing motions, ability to take a temperature and for the doll run a fever, and the ability to simulate a rash.

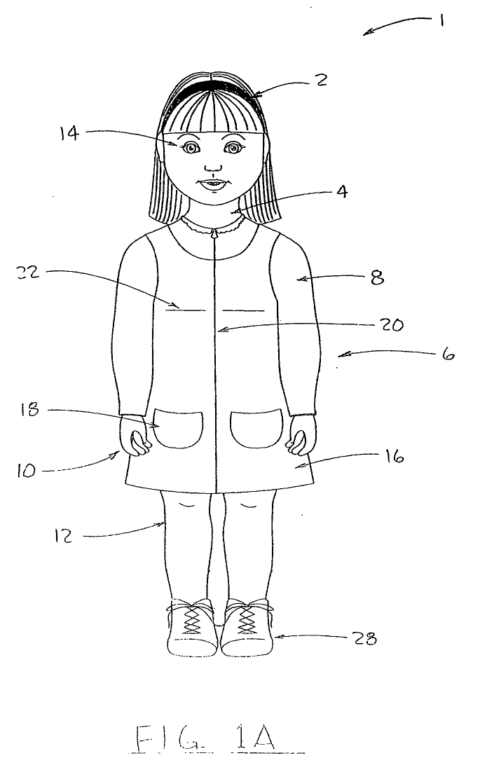

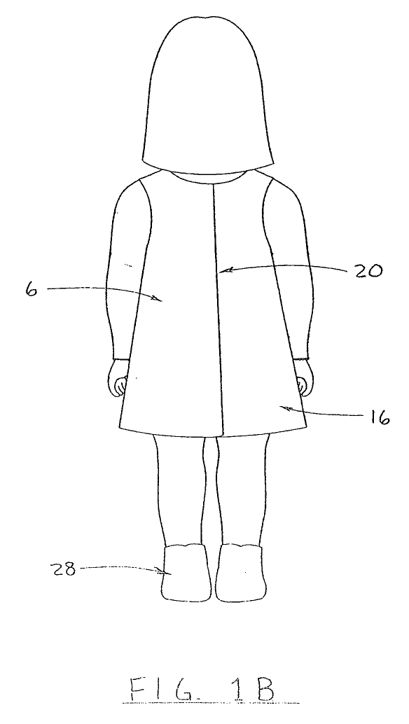

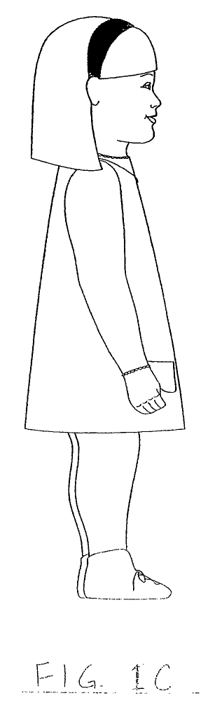

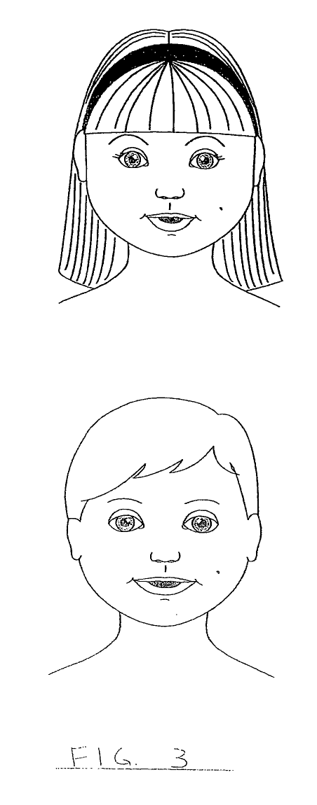

FIGS. 1, 2 and 3 contain representative views of the interactive doll of the present invention for educating a child as to the medical treatment of a childhood chronic illness, including but not limited to asthma, allergies, cystic fibrosis, and diabetes. The doll has the external appearance of a conventional toy to appeal to young children. The doll may be human shaped, and preferably resembles a small child. The toy may reflect age, race, or gender. In one embodiment, the toy may resemble a fictional figure such as an action hero or cartoon character. In another embodiment, the present invention may be in the form of a stuffed animal. The doll may also be programmable in many languages.

The body of the toy may be composed of any suitable material, however, a soft, flexible and durable material is preferable to protect the inner electrical circuitry and allow for easy care. In one embodiment, the doll 1 is poseable, having a head 2, neck 4, torso 6, arms 8, hands 10, and legs 12 having a soft flexible outer covering. The doll's neck 4, arms 8, hands 10, and legs 12 may be jointed to allow for posing and mobility of the doll. Joints may be provided in the legs 12 to allow for positioning of the doll in a sitting or kneeling position, while joints in the arms 8 and hands 10 may permit the doll to simulate holding a book and other items such as an inhaler or other pseudo-medical equipment. The doll's eyes 14 may be fixed or moveable. In one embodiment, the eyes are the pivoting joint type which close and are covered by “eye lids” when the doll is placed in a horizontal position, allowing for the simulation of sleep. In another preferred embodiment, the eyes may be motorized, and are controlled through an electronic connection to a microprocessor.

FIGS. 1A, 1B, and 1C illustrate the front, back, and side view of a female embodiment of the clothed doll. The doll is provided with removable clothing 16. which clothing 16 may reflect the age, race, or gender of the doll. The doll's clothing 16 is appealing to small children, and may be made of a machine washable fabric such as cotton or polyester. The clothing, which covers the doll's torso, may contain pockets 18 for placing small objects. The clothing may contain one or more non-appendage openings 20B for easy access to the doll torso. Preferably, the openings 20B are vertical slits which may be closed by one or more fasteners, including but not limited to zippers, buttons, hooks, Velcro™, or the like. The clothing may include an area or strip 22 for removable attachment of a nametag or alphabetic letters for personalization of the doll. FIG. 1A shows exemplary clothing 16 in the form of a dress having a vertical front non-appendage opening 20B from the top collar line to the base of the dress, for easy access to the doll's torso 6, and particularly to the chest and heart region. FIG. 1B shows the back of the clothing having a vertical non-appendage opening 20B running the length of the dress for easy access to the back of the torso 6, particularly to the lung region. The doll preferably is wearing shoes 28.

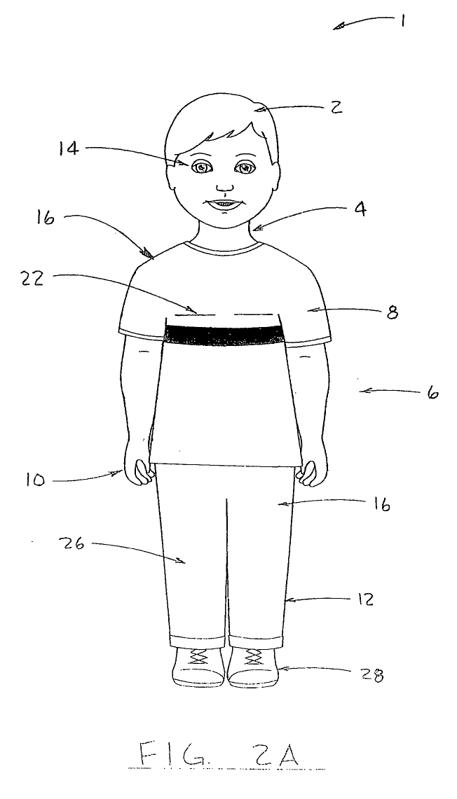

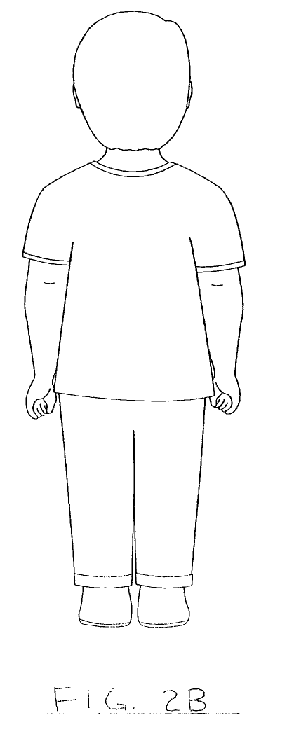

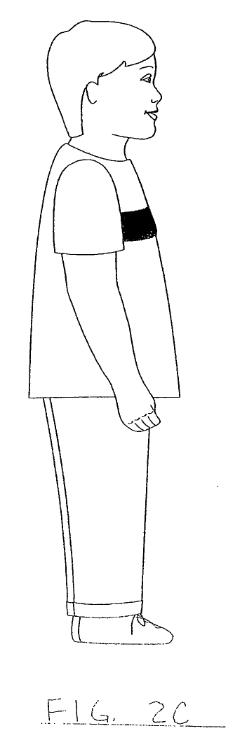

FIG. 2A, 2B, and 2C illustrate a male embodiment of the doll showing a front, back, and side view of the male clothed doll, respectively. The clothing 16 for the male doll preferably includes a shirt having one or more non-appendage openings 20, and may also include pants 26 and shoes 28. The clothing for either the male or female or other embodiment may have additional openings to provide easy access to areas of the body that may require treatment for illnesses other than those discussed here.

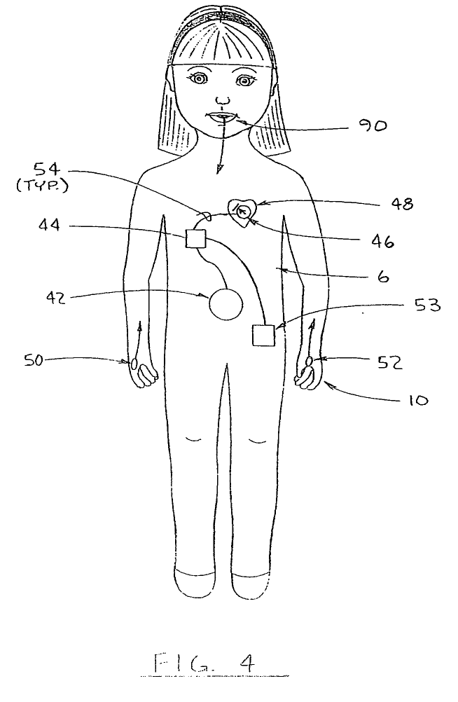

Referring to FIG. 4, a cut-away view of the front of the doll is illustrated to show internal electronically connected components which interact to produce various responses of the doll to interaction with the user, pseudo-medical equipment, or story book. This particular layout is specific to the asthma version of the doll. Sensor types, locations and number may be changed as necessary to simulate various additional medical conditions. The torso 6 of the doll contains a speaker 42, which may be located in the abdominal region, for output of recorded audio. The speaker 42 preferably projects audio output through the front of the doll's torso 6 using methods well known to those skilled in the art. The speaker 42 is electronically connected to a microprocessor 44, which provides signals to the speaker 42. The microprocessor 44 is preferably programmable, and may be of any type known to those skilled in the art. The doll torso 6 further contains one or more internal proximity switches 46 which can be triggered by a magnet, electronic signal, passively activated microchip or similar activator known to those skilled in the art. The activator is located on, or within, items of pseudo-medical equipment, and is used to trigger a switch 46, completing an electrical circuit and sending an electronic signal to the microprocessor 44. The microprocessor 44 processes the signal to provide a response by the doll. The microprocessor may trigger a programmed audible response from the audio speaker consisting of: coughing sounds, wheezing sounds, speech, heart sounds, bowel sounds, breathing, lung sounds, or other audible sound. In alternative embodiments, the microprocessor may trigger known responders within the toy, including but not limited to light bulbs, diodes, resistors, heating elements, or vibrating motors, in heat emission, light emission, and/or motion of the toy.

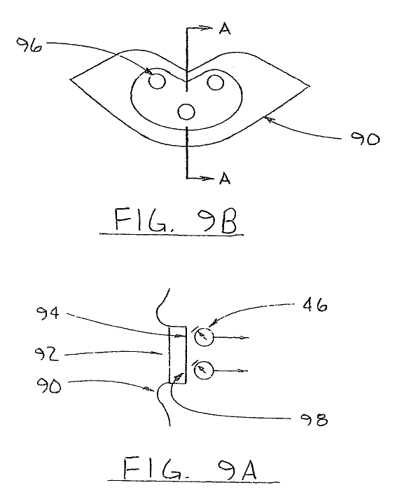

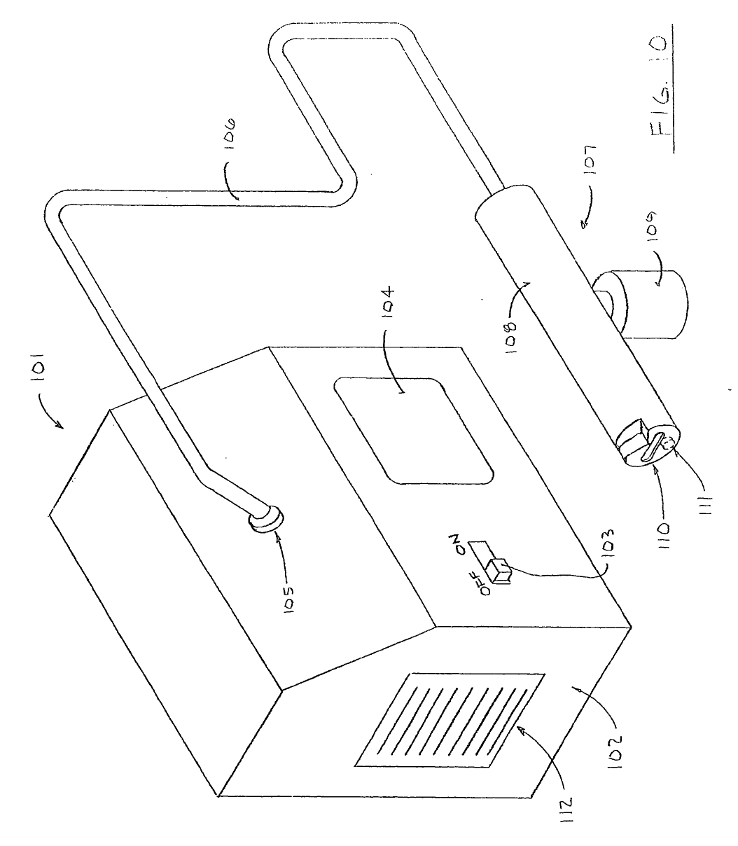

Preferably, the location of each proximity switch 46 is marked on the outer surface of the doll torso. In one embodiment, an internal proximity switch 46 is located to approximate the location of the human heart, and the location of the proximity switch 46 is marked by a heart symbol 48 on the outer surface of the doll torso. Three proximity switches (shown in FIG. 9) are also located in the doll's mouth 90. The switches occupy a preferred orientation as described in FIG. 9, to relay signals from the peak flow meter, nebulizer and inhaler pieces of pseudo-medical equipment.

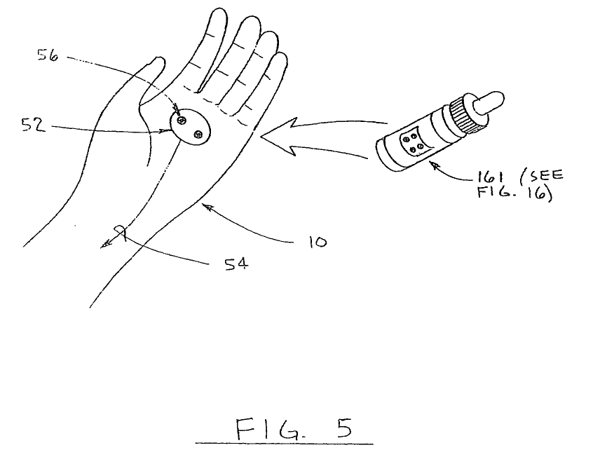

A radio frequency sensor (receiver) 53 is located in the doll's torso and is triggered when an item of pseudo-medical equipment is placed near the doll such that a microchip within the equipment is passively coupled to the sensor and a signal is received. Preferably, each object has its own RF identity, allowing the doll to “know” which piece of equipment is near-by and to select the proper audio response for the item. Other types of recognition systems known to those skilled in the art can be used in place of a passively coupled RF system. Such systems include, for example: physical contact (metal-to-metal) between the object and an exposed metal connector on the doll's body, as described in FIG. 5; or wireless systems not dependent on physical contact, such as infrared or other known optical means.

In another embodiment, the activator is a magnet located within a piece of pseudo-medical equipment. Preferably, at least one activator is located on, or within, the end of a toy stethoscope such that when the activator is placed close to a proximity switch 46 located in the heart region of the torso 6, the switch 46 closes to complete an internal electrical circuit, signaling the microprocessor 44 to send an audio signal to the speaker 42 which simulates the sound of a heartbeat. Other proximity switch embodiments can include, but are not limited to, switches that approximate the location of lungs, kidneys, pancreas, bowels, and the many locations used for taking blood for glucose readings and administering insulin shots, and which can signal the microprocessor to generate audio or other responses from the doll.

FIG. 5 details a second contact sensor 52 which is located in the thumb region of in the doll's hand 10. This type of sensor may be used in place of or in conjunction with the passive radio frequency system describe above to allow the doll to identify pieces of pseudo-medical equipment and respond to them. Preferably, the second contact sensor 52 is located in the opposite hand from the first contact sensor 50. The second contact sensor 52 may be of any type known to those persons skilled in the art. The sensor 52 is electronically connected to the microprocessor 44 using internal electrical wiring 54, and triggers an electronic signal when a conductive item is placed in the dolls' hand. In one embodiment, the second contact sensor 52 utilizes one or more electrically conductive contact points 56 which correspond to one or more electrically conductive contact points on an item of pseudo-medical equipment which can be placed in the doll's hand. In another embodiment, all or a portion of the pseudo-medical equipment may have corresponding electrical contact points. The medicine dropper bottle is presented here as an example.

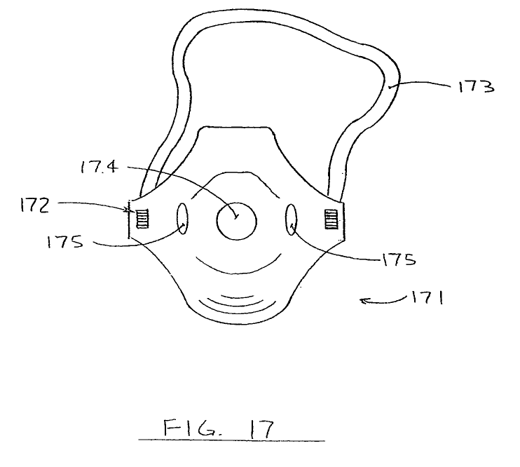

Referring to FIG. 5 and FIG. 16, in one embodiment, a medicine dropper bottle 161 is provided having a cylindrical bottle portion 162 containing one or more electrically conductive contact points 166 having metal depressions for placement of the medicine dropper bottle into the doll's hand 10, causing the contact points 166 to touch the corresponding contact points 56 in the doll's hand. The contacting of points 166 and 56 complete the electrical wiring 54 circuit to the microprocessor 44, which generates an audible response. In a preferred embodiment, each item of pseudo-medical equipment has a different resistor (not shown) connecting the contact points 166, such that when an item is placed in the doll's hand 10, an electrical circuit is completed having an electrical current determined by the resistor in the item. In this embodiment, the microprocessor is programmed to identify the resistance generated by each item and to generate a corresponding audible response from the doll. By way of example, when the medicine dropper bottle 161 is placed in the doll's hand, the resulting resistive electrical current can signal the microprocessor to play an audible recording that advises that the doll does not like to take medicine, but that it helps treat unpleasant symptoms.

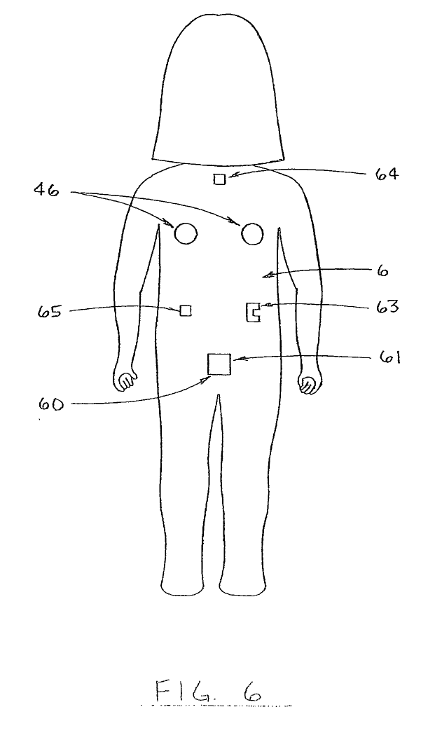

FIG. 6 illustrates a rear cut-away view of the unclothed doll. The doll torso 6 contains an internal electrical power source 60, preferably utilizing one or more rechargeable batteries. Preferably, the power source includes an internal battery housing of a type well known in the art. The size and number of batteries are determined by the power needs of the microprocessor, sensors, contacts, and other features of the doll. The internal power source 60 may be accessed though an external panel 61. The battery access panel 61 is held closed by a fastening device to allow access by adults, but avoid being easily opened by a child. In one embodiment, the fastening device includes screws. In one embodiment, the panel 61 contains an external recharging port of a type well known in the art.

FIG. 6 further illustrates two or more internal proximity switches 46 located on the back of the doll, each preferably having a corresponding symbol to mark its location on the outer surface of the torso 6. Preferably, at least two of the proximity switches 46 approximate the location of human lungs, and can be activated by an activator in the toy stethoscope to trigger the microprocessor 44 to generate a good or poor breathing sounds through the speaker 42.

The back of the doll also contains a master switch 63, preferably having at least two positions including, but not limited to “Off” and “On”. Further, the doll preferably includes a book play switch 64 which triggers the microprocessor to generate recorded audible recitation of text of a book which is provided with the doll. The book play switch 64 may be of any type known to those skilled in the art. In one embodiment, the play switch 64 is a simple pressure sensitive contact switch. In one embodiment, depressing the play switch 64 once signals the microprocessor to begin recitation of the audible text which corresponds to the short story, and depressing the play switch again stops the reciting.

The doll also provides one or more communication ports 65 for inputting data to the microprocessor from an external source. Preferably, the communications ports 65 are compatible with an exterior keyboard, PC connector, and other communications devices which are well known to those skilled in the art. In another embodiment, the microprocessor 44 and associated software can be programmed or modified by linking the communications ports 65 to an external communications device, including but not limited to a personal computer (“PC”). Plugging the appropriate device into the connector on the doll causes the doll to recognize its presence and begin a programming session.

In one embodiment, the external communications device can be used to program the doll's microprocessor with information including, but not limited to, data such as the child's name, the doll's name, date, time, disease information, audio and story book text. The doll's microprocessor software is preferably compatible with PCs such that the doll can be reprogrammed from an external PC. Such programming will permit the doll to simulate additional or alternate diseases symptoms. In this embodiment, entire training or learning scenarios can be run using PC input.

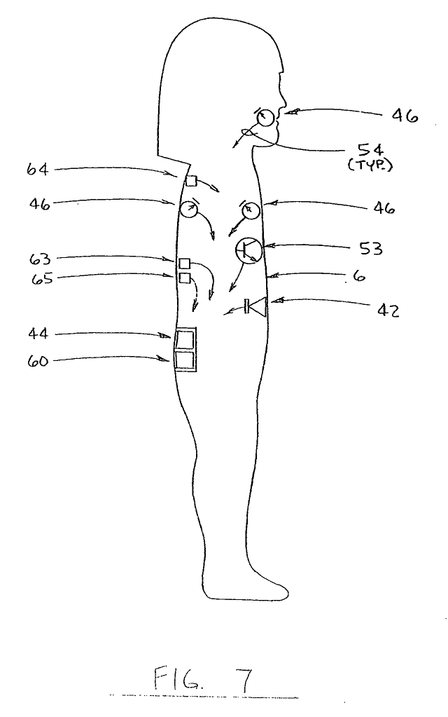

FIG. 7 illustrates a cross sectional side view of the doll's torso 6, showing a preferred embodiment of the internal electronic connections for the internal components described herein. As previously described, the doll's hand 10 contain a contact sensor 50 which is connected to the microprocessor 44 by electrical wiring 54. One or more proximity switches 46 are preferably located in various positions throughout the torso and head, and are connected to the microprocessor 44 by electrical wiring. An internal power source 60 is preferably located in the doll's torso 6, and is connected to the microprocessor 44 by electrical wiring 54. The master switch 63 is preferably located on the lower right quadrant of the doll's back, and is connected to the microprocessor 44 by electrical wiring 54. A play switch 64 is preferably located on the upper middle of the doll's back, and is connected to the microprocessor 44 by electrical wiring 54. The microprocessor 44 is electronically connected to one or more speakers 42 which are preferably located in the doll's abdominal region. The microprocessor 44 is programmed to identify electronic signal inputs, and to send programmed corresponding output signals to the speaker 42. In this embodiment, a RF sensor 52 is located in the doll's abdomen and is connected to the microprocessor by electrical wiring 54.

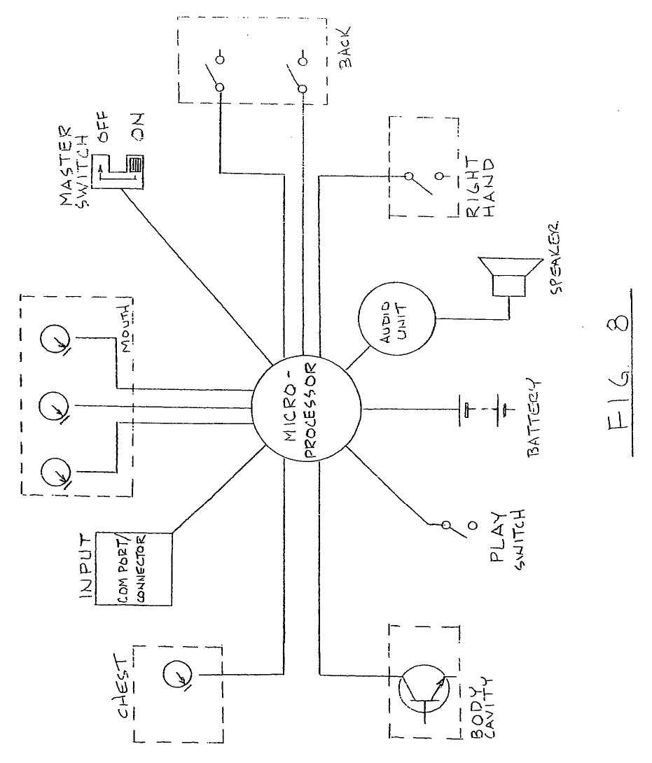

FIG. 8 illustrates a preferred electrical schematic of the asthma version of the doll described herein. The various input and output devices connected to the microprocessor are depicted. However, the doll's internal electrical circuitry may be easily altered or adapted by those skilled in the art without undue experimentation. In one embodiment, the doll's internal electrical circuitry and microprocessor may include an internal clock and software, which can generate responses from the doll at either pre-programmed or random times. In another embodiment, the doll's circuitry is closed only when a sensor or switch is activated, and is otherwise open so that no power is consumed. In yet another embodiment, the doll may utilize a “sleep” or battery saving mode, which is well known to those skilled in the art. For example, if no sensor or switch inputs are received by the microprocessor for a pre-determined time, the microprocessor software will cause the doll to simulate a sleep mode by temporarily discontinuing microprocessor output until a sensor or switch is activated, but continuing internal clock functions.

FIG. 9B is front view of the doll's mouth 90, and FIG. 9A is a cross-sectional side view of the doll's mouth 90. The doll's mouth 90 contains a recessed opening 92 having a rear wall 94 having one or more sensor locations 96. Preferably, each sensor location 96 contains a proximity switch 46 which is positioned to align with one or more activators on items of pseudo-medical equipment which can be placed in contact with the doll's mouth 90. In one embodiment, specific to asthma, the activators are located on pseudo-medical equipment including, but not limited to, a nebulizer, inhaler, and peak flow meter. The proximity switches 46 may be covered with a thin, opaque plastic covering 98 to protect the sensors from damage.

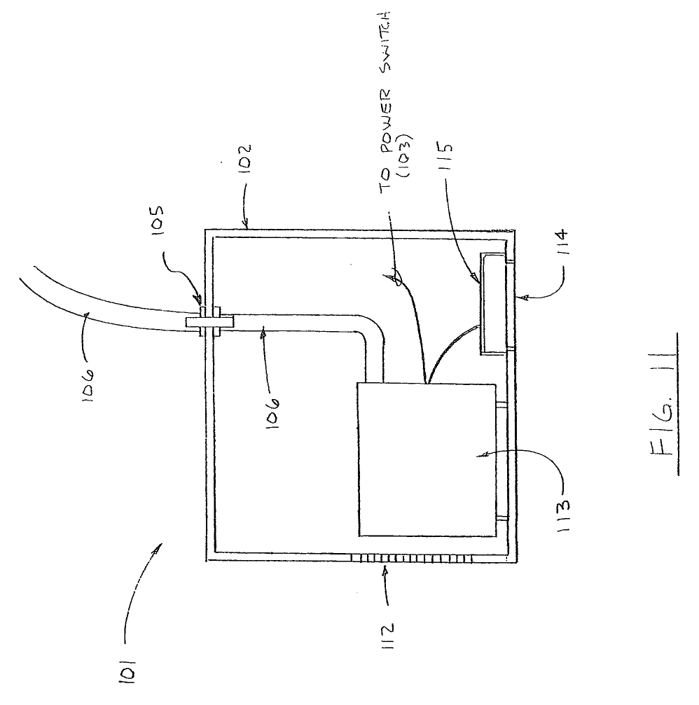

FIG. 10 illustrates pseudo-medical equipment in the form of a toy nebulizer 101 consistent with usage in the asthma and cystic fibrosis versions of a pseudo-medical equipment kit. In one embodiment, the nebulizer 101 includes a rectangular shaped main housing 102 having a power switch 103 and a decal 104 on the front of the nebulizer 101. The main housing 102 may be manufactured from a polymeric material, and is scaled appropriately for use with the doll. In the most preferred embodiment, the main housing is approximately 5″ long, 3″ high, and 2″ deep. -The nebulizer housing 102 includes an air outlet connector 105, and an air vent 12. A flexible tube 106 connects the air outlet connector to the medicine dispensing unit 107. The medicine dispensing unit 107 may be approximately 4″ in length, and is comprised of hollow polymeric tube 108 connected to a perpendicular connecting cylinder 109. The flexible tube 106 connects to one end of the long hollow polymeric tube 108, and preferably can be disconnected so that the child may simulate the washing of the medicine dispensing unit 107. The opposite end of the long hollow polymeric tube terminates to form a mouthpiece 110 which is shaped to fit into the recessed opening 92 of the doll's mouth 90 in a specific orientation. The mouthpiece 110 includes an activator 111, which may be comprised of one or more permanent magnets, which correspond to the sensor locations 96 in the doll's mouth 90. In one embodiment, the nebulizer mouthpiece 110 is keyed to fit into the recessed opening 92 of the doll's mouth 90 in one orientation only, causing alignment of the permanent magnet 111 with the sensor 46 (shown in FIG. 9) in the doll's mouth. This activates one or more proximity switches 46 in the doll's mouth 90 closing an internal electrical circuit in the doll and sending a signal to the microprocessor 44 to generate an audible response. The toy nebulizer may also contain a microchip (not shown) as part of the passively coupled RF system such that the doll will “recognize” the object when it is in close proximity to the body cavity RF sensor and respond with an audible phrase specific to the piece of equipment. In one embodiment, the nebulizer 101 may simulate production of a mist from the mouthpiece to increase the similarity to what a child experiences while using the real equipment.

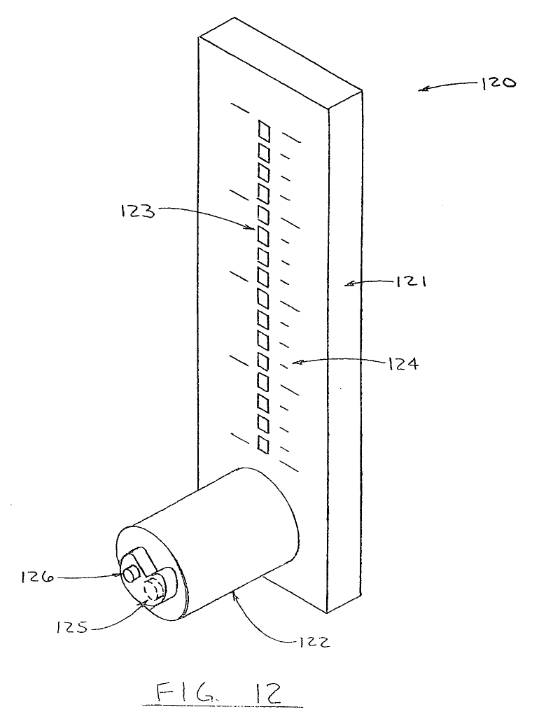

FIG. 11 illustrates a cut-away view of one embodiment of the nebulizer 101 in which it may simulate production of a mist. The mechanical method described follows that of a real working nebulizer. Larger dimensions for the nebulizer main housing unit than those given in FIG. 10 are required for this embodiment, preferably 8″ long, 6″ high, and 6″ deep. A small air compressor 113 is located inside the nebulizer's main housing unit 102. An air intake opening 112 is located on a wall of the main housing unit 102. The compressor can be electrically powered by an internal battery source 115 or an external electrical source (not shown). The bottom of the nebulizer housing 102 may contain a battery access panel 114. When power is activated by turning on the power switch 103, the compressor 113 produces an air flow output which is conveyed through the air outlet connector 105, through the flexible tubing 106. The air flow output in psi must be kept within a safe range for a children toy, but must be powerful enough to produce the mist effect with the desired length of tubing 106. When the compressed air flow reaches the medicine-dispensing unit 107, the air mixes with water that has been placed into the medicine-dispensing unit, producing a mist. Another opening can be provided in the medicine dispensing unit 107 to allow the mist to escape. In one embodiment, approximately one teaspoon of water may be added to the short cylinder 109 of the medicine-dispensing unit 107 to generate mist. In this embodiment, the medicine-dispensing unit 107 resembles the design of a real compressed air medicine dispensing unit, which is well known to those skilled in the art. In another embodiment of the toy nebulizer 101, the misting effect may be created by the placement of an ultrasonic resonator which operates using the same technology and components used in of real ultrasonic nebulizers.

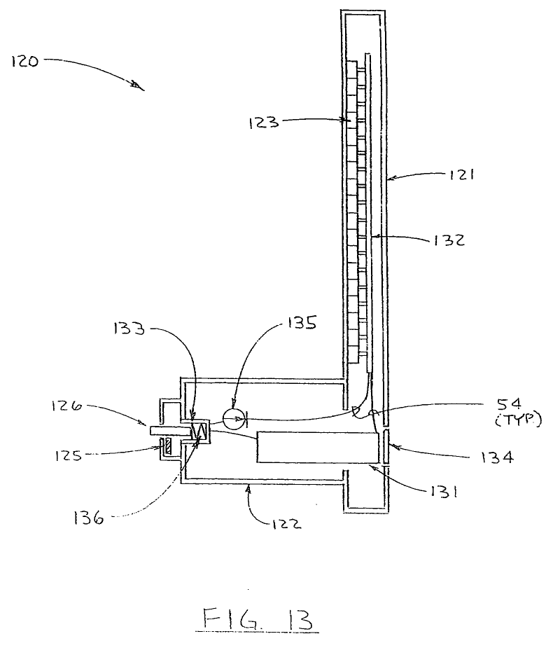

FIG. 12 shows pseudo-medical equipment in the form of a toy peak flow meter 120 consistent with usage in the asthma pseudo-medical equipment kit. The peak flow meter 120 comprises a rectangular shaped vertical housing 121 having a perpendicular connecting mouthpiece 122. The peak flow meter is scaled to be compatible with the doll. In a preferred embodiment, the meter is approximately 6″ high, 1½″ wide, and 3″ from the end of the mouthpiece 122 to the back of the vertical housing 121. The peak flow meter 120 may be made from any suitable material, and is preferably a polymeric material. The vertical housing 121 includes a scale, which is preferably comprised of a series of light-emitting diodes (“LED”) display lights 123. Markings 124 for the scale are present on the vertical housing 121, preferably in the form of marks and numbers ranging from the numeric value of 50 to the numeric value of 250. The marks can be formed into the vertical housing 121 in the manufacturing process or affixed as a label, sticker or decal. The mouthpiece has a protruding rigid shape that corresponds to the recessed opening 92 in the mouth 90 of the doll, which permits the mouthpiece to fit into the doll's mouth in one orientation only. In one embodiment, the mouthpiece 122 of the peak flow meter further contains an activator 125 which contacts one or more sensor locations 96 in the rear wall 94 of the doll's mouth 90 when the mouthpiece 122 is inserted correctly. Contact of the activator 125 with a sensor location 96 causes a proximity switch 46 in the doll's mouth to activate, sending an electrical signal to the microprocessor 44 which identifies the presence of the peak flow meter 120 and generates an audible response. In one embodiment, the pseudo-peak flow meter mouthpiece contains a permanent magnet oriented to trigger a specific sensor in the doll's mouth.

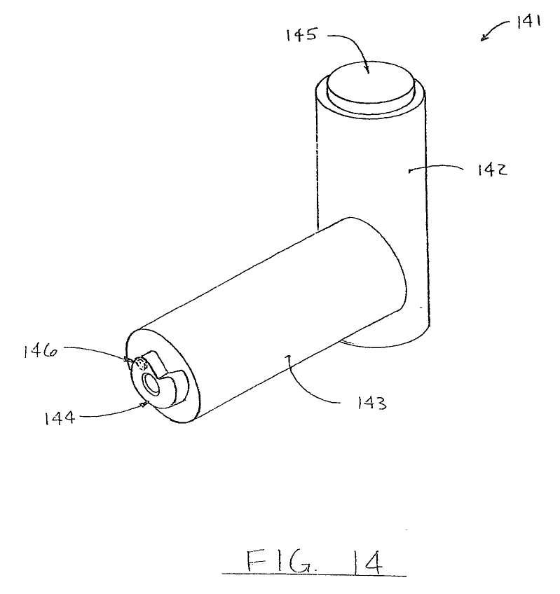

FIG. 13 illustrates a cut-away side view of the toy peak flow meter 120 consistent with usage in the asthma pseudo-medical equipment kit. A battery power source 131 may be located inside the perpendicular connecting mouthpiece 122. The power source is connected to a contact switch 135, which is also housed inside the perpendicular connecting mouthpiece 122. The peg 126 has a metal disk 133 affixed to the inner end. When the mouthpiece is correctly placed in the doll's mouth 90, the outer end of the peg will contact the rear wall 94 causing the peg 126 to depress. In one embodiment, the inward movement of the peg 126 may be controlled by a circular recess in the tube wall. In this embodiment, the peg 126 preferably rests on a spring 136 at the base of the circular recess, allowing the peg 126 to retract to it's initial position when the mouthpiece 122 is removed from the doll's mouth 90. When the peg 126 is depressed flush with the mouthpiece, the metal disk 133 contacts an electrical wire 54 connected to the contact switch 135, completing a connection to the circuit board 132 which controls the LED light display 123. Preferably the circuit board is programmed to light the LED display in series, leaving the highest or last LED lit for several seconds to indicate a final peak flow meter reading. The rear of the peak flow meter may contain a battery access door 134 for replacement. The door 134 is held closed by a fastening device to allow access by adults, but avoid being easily opened by a child. In one embodiment, the door 134 is fastened by screws for easy access by adults, but preventing access by young children. It is understood that should an illuminated LED scale not be desired, a simpler scale may be provided. In another embodiment, the toy equipment is interactive with the doll's microprocessor, such that the microprocessor senses the presence of the equipment, generates a signal to the equipment to simulate a reading, and signals an available response from the doll. The required electrical interface of the equipment and the doll can be assembled, using technology well known to those skilled in the art without undue experimentation. The toy peak flow meter may also contain a microchip (not shown) as part of the passively coupled RF system such that the doll will “recognize” the object when it is in close proximity to the body cavity RF sensor and respond with the audible phrase specifically for this piece of equipment.

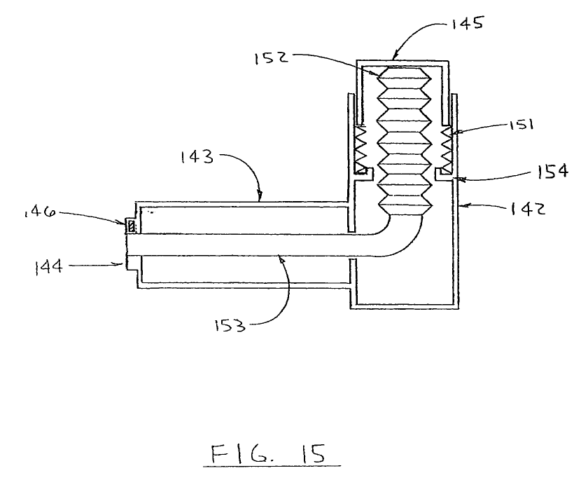

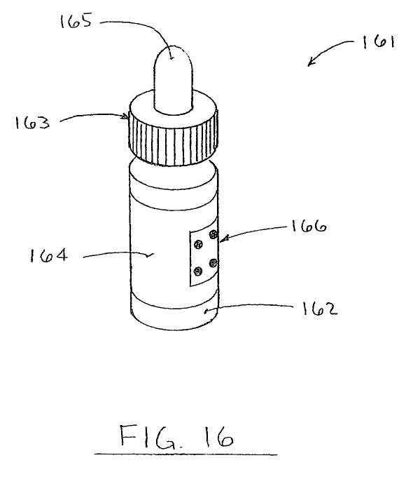

FIGS. 14 and 15 illustrate pseudo-medical equipment in the form of a toy inhaler 141 consistent with usage in the asthma and cystic fibrosis versions of a pseudo-medical equipment kit. The inhaler 141 comprises a vertical cylinder section 142 with a perpendicular cylindrical air chamber 143. The inhaler dimensions are compatible with the doll's size. In a preferred embodiment, the inhaler is approximately 3″ high along the length of the vertical cylinder 142, 4″ deep from the end of the mouthpiece 144 to the back of the vertical cylinder 142, and approximately 1½″ wide. At one end of the air chamber 143 is a mouthpiece 144 which is preferably shaped to correspond with the recessed opening 92 of the doll's mouth 90 such that the mouthpiece 144 fits into the doll's mouth 90 in one orientation only. Preferably, the inhaler 141 is made from a polymeric material, and simulates the operation of a real inhaler. In one embodiment, the inhaler 141 includes a button 145 located at the top of the vertical cylinder 142, which is axially slidable and which is maintained in an upward bias by one or more compression springs 151 inside the vertical cylinder 142. The springs can rest on an inner lip 154 which projects from, and is part of, the cylinder shaped vertical section 142. The depression of the button 145 compresses an air bellows 152 which is connected to a plastic tube 153 extending through the perpendicular cylindrical air chamber 143 and terminating in an opening at the mouthpiece 144. When the button is compressed, air is-forced from the bellows 152 through the tube 153, resulting in a puff of air from the mouthpiece 144. This will allow the child to simulate the process of administrating medicine via an inhaler by depressing the button 145. The mouthpiece 144 further includes an activator 146 that activates a switch in the doll's mouth, sending a signal to the microprocessor. In a preferred embodiment, the activator is a magnet. It is understood that should a working toy inhaler not be desired, an embodiment is provided which has the external appearance of an inhaler, but has no moving parts. The toy inhaler may also contain a microchip (not shown) as part of the passively coupled RF system such that the doll will “recognize” the object when it is in close proximity to the body cavity RF sensor and respond with the audible phrase specifically for this piece of equipment.

FIG. 16 illustrates pseudo-medical equipment in the form of a medicine dropper bottle 161 consistent with usage in the asthma pseudo-medical equipment kit. The medicine dropper bottle may have a cylindrical portion 162 and a simulated cap 163 having a hollow bulb 165 made from resilient resinous material. In one embodiment, compression of the bulb 165 simulates the drawing of medicine from the bottle. The bottle portion 162 may contain a label 164 reflective of a real medicine dropper bottle label. The medicine dropper bottle may contain a microchip (not shown) as part of the passively coupled RF system such that the doll will “recognize” the object when it is in close proximity to the body cavity RF sensor and respond with the audible phrase specifically for this piece of equipment. As described for FIG. 5 above, this item also includes one or more electrically conductive contact points 166 having metal depressions for placement of the medicine dropper bottle into the doll's hand 10.

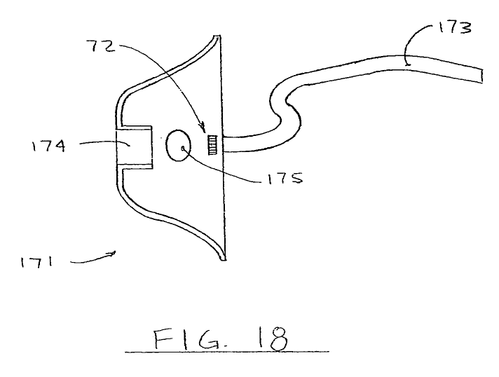

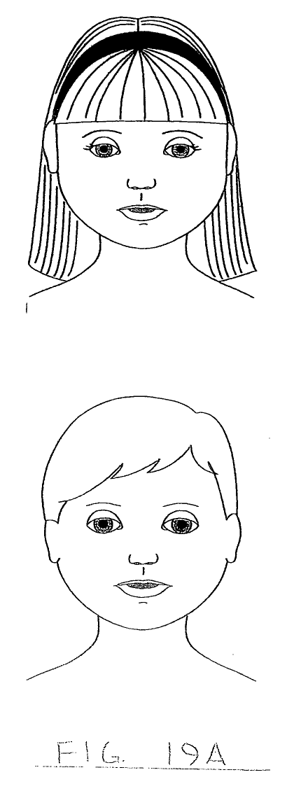

FIG. 17 and 18 illustrate pseudo-medical equipment in the form of a toy mask 171 for use with the asthma, allergy and cystic fibrosis versions of the doll of the current invention. The mask is of a size compatible with the doll. In a preferred embodiment, the mask dimensions are approximately 2″ by 2″. The mask may be made from any suitable soft, flexible material, but is preferably made from transparent polymeric material. The mask may include an elastic strap 173, which is connected to the side edges 172 of the mask 171. In one embodiment, an opening 174 is located in the center of the mask to allow use of the mask 171 in conjunction with other pseudo-medical equipment such as the medicine dispensing unit 107. The opening 174 may be slightly larger than the mouthpiece on any pseudo-medical equipment to facilitate easy placement of the mask 171 over the end of the mouthpiece. In another embodiment, smaller openings 175 may be provided closer to the side edges 172 of the mask to simulate vent holes.

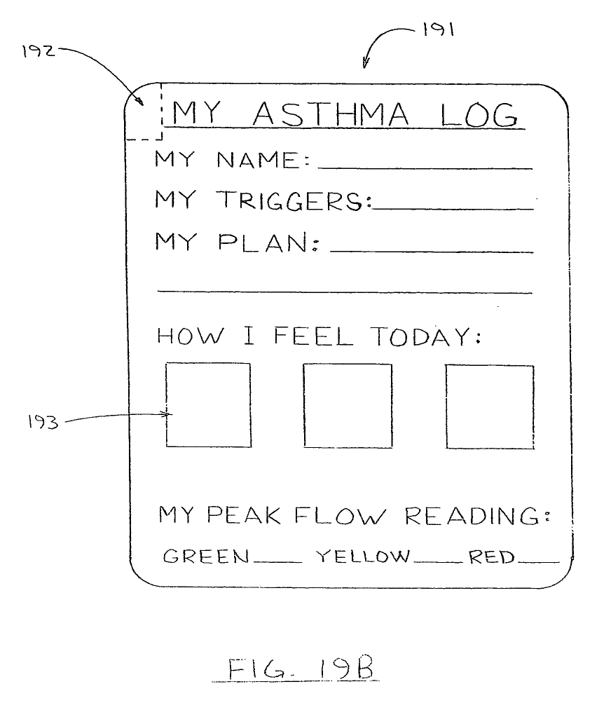

FIG. 19 illustrates pseudo-medical equipment in the form of a toy patient chart 191. The chart 191 is of a size compatible with the doll. In one embodiment, the chart is approximately 5″ by 6″. The chart may be comprised of a laminated cardboard to allow a child to easily write and erase on the chart 191. The chart may contain a microchip 192 as part of the passively coupled RF system such that the doll will “recognize” the object when it is in close proximity to the body cavity RF sensor and respond with the audible phrase specifically for this piece of equipment. In another embodiment, the chart 191 contains areas 193 for the child to indicate how they feel on a given day, which may include various character facial expressions for selection by the child. By way of example, and without limiting the invention, FIG. 19A and FIG. 19B each show various facial expressions, which can be included on the patient chart. FIG. 19A depicts an expression of not feeling well, while FIG. 19B depicts an expression of feeling fine.

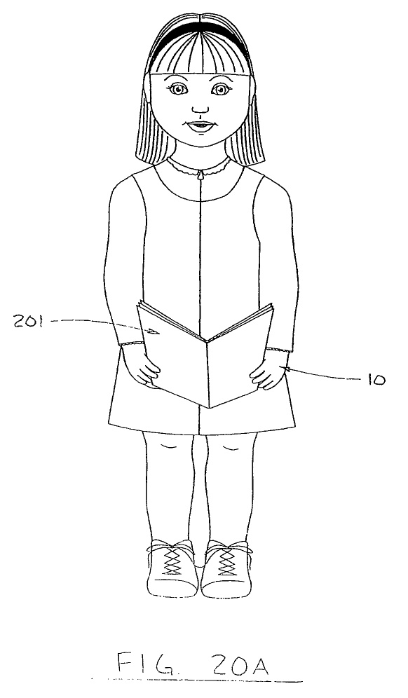

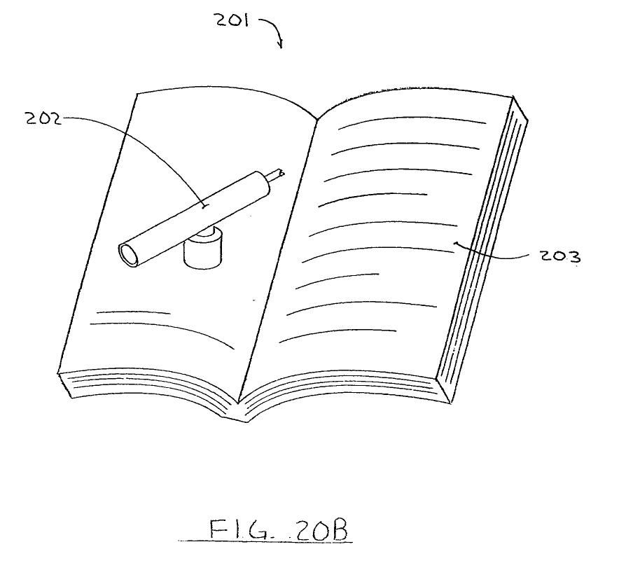

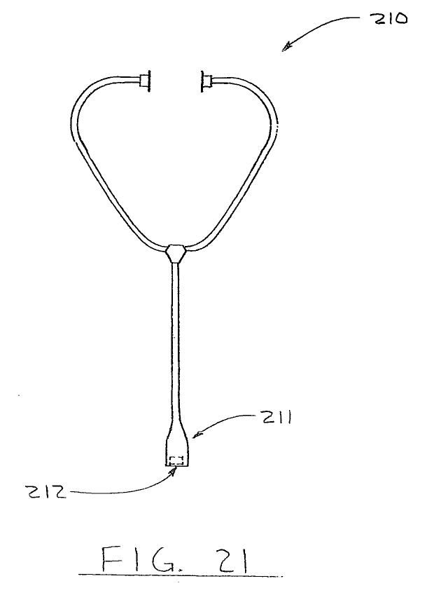

FIG. 20B illustrates a child's book 201 in accordance with the present invention. In one embodiment, the book 201 may contain illustrations 202 and story line 203 suitable for explaining a chronic illness to children. The book is of a size, which is compatible for use by the child and the doll. In one embodiment, the book is approximately 6″ high by 5½″ wide, and includes less than thirty pages featuring illustrations and text concerning real children and the doll of the current invention. The book may be educational and entertaining, and should be developmentally appropriate to a defined age set. Another embodiment of the book 201 may be more reflective of an instructional booklet, and may be developmentally appropriate for older children. This embodiment may use language indicative of the older child and is intended for reinforcement of specific concepts taught by the doll and the child's management team. This embodiment is one of instruction, rather than defined story line.

FIG. 20A illustrates the doll of the present invention holding the book 201. In one embodiment, the book 201 contains one or more electrically conductive contact points (not shown) which may be connected internally using the same resistive technology previously described for the medicine dropper bottle 161, such that when the book is placed in the doll's hand 10, the contact points touch the corresponding contact points 56 in the doll's hand, completing the electrical wiring 54 circuit to the microprocessor 44, which generates an audible response.

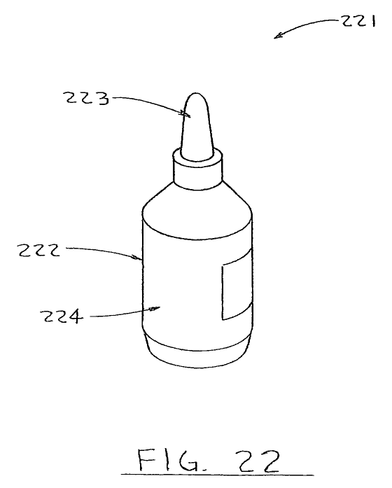

FIG. 21 illustrates pseudo-medical equipment in the form of a toy stethoscope 210 consistent with usage in the asthma, cystic fibrosis, diabetes or other pseudo-medical equipment kits. The toy stethoscope resembles a real stethoscope, and is of a size compatible for use by a child to simulate treatment of the doll. In one embodiment, the stethoscope is approximately 16″ in length, and is sized such that the listening end fits the head of a child . The stethoscope may have a cup-shaped end 211 comprising an activator 212. The activator 212 may be a permanent magnet encased in plastic. In a preferred embodiment, when the cup shaped end 211 is placed in proximity to a proximity switch 46 on the doll's torso 6, the activator 212 closes the switch to complete an electronic circuit to signal the microprocessor 44 to generate an audible response. In another embodiment, the cup-shaped end 211 of the stethoscope contains a peg (not shown) which is shaped to fit into one or more corresponding contact sensors which can be provided on the doll's torso 6 to complete a circuit and trigger an audible response. The toy stethoscope may also contain a microchip (not shown) as part of the passively coupled RF system such that the doll will “recognize” the object when it is in close proximity to the body cavity RF sensor and respond with the audible phrase specifically for this piece of equipment.

FIG. 22 illustrates pseudo-medical equipment in the form of a toy nose sprayer 221 consistent with usage in the asthma and allergy pseudo-medical equipment kits. The nose sprayer is of a size compatible with the doll. In one embodiment, the nose sprayer 221 is approximately 2½″ in length and 1″ in diameter, and is made from a polymeric material. The nose sprayer 221 may comprise a cylinder unit 222 with a simulated spray tip 223. A label 224 may appear on the face of the sprayer 221. The toy nose sprayer may also contain a microchip (not shown) as part of the passively coupled RF system such that the doll will “recognize” the object when it is in close proximity to the body cavity RF sensor and respond with the audible phrase specifically for this piece of equipment.

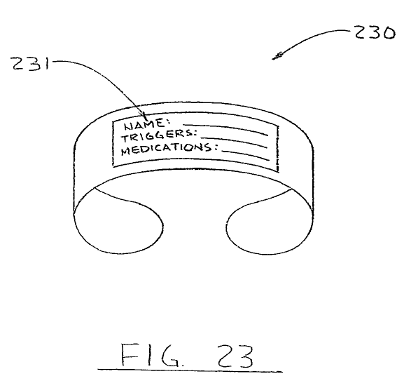

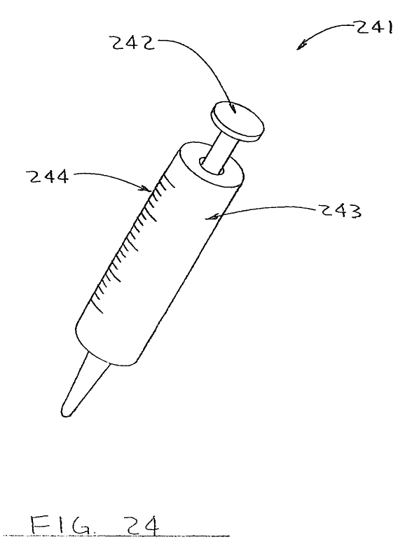

FIG. 23 illustrates a toy medical identification bracelet 230. The bracelet 230 may be of a size that can be worn by the doll or by a child. The bracelet 230 may be made of any suitable non-toxic material. In one embodiment, the bracelet 230 is made of a thin polymer material, and is flexible enough so that it can easily and removably be placed on the doll's wrist or the child's wrist. In one embodiment, the bracelet 230 includes a decal 231 for placement of the outer face of the bracelet, the decal 231 having text and adequate space for a child to write the doll's name, illness, medications, and other information. The toy medical identification bracelet may also contain a microchip (not shown) as part of the passively coupled RF system such that the doll will “recognize” the object when it is in close proximity to the body cavity RF sensor and respond with the audible phrase specifically for this piece of equipment.

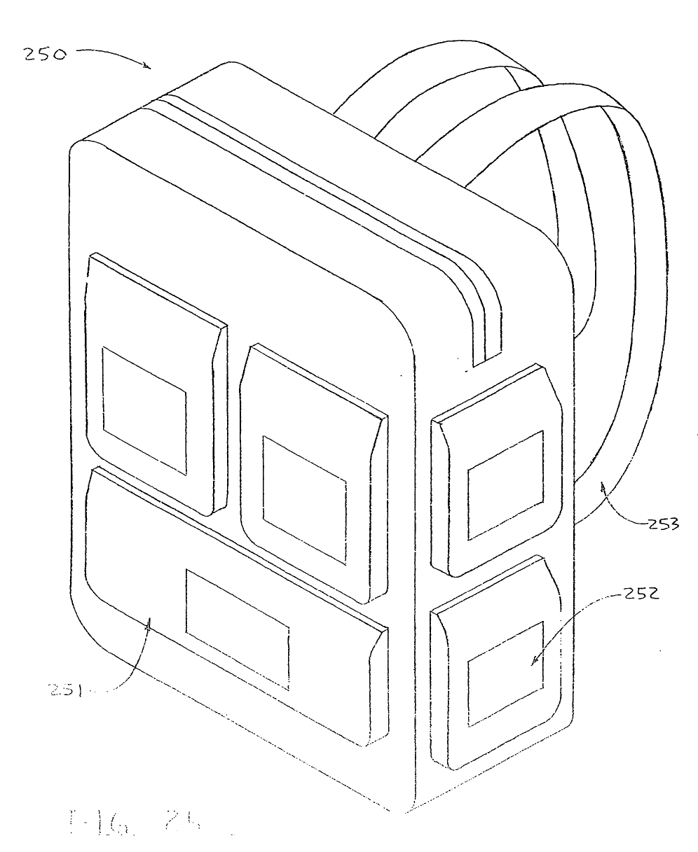

FIG. 24 illustrates pseudo-medical equipment in the form of a toy syringe 241 consistent with usage in the asthma pseudo-medical equipment kit. The syringe 241 is of a size compatible with use by a child to simulate treatment of the doll. In one embodiment, the syringe is approximately 2½″ in length and 1″ in diameter, and is made from a polymeric material. In one embodiment, the top plunger 242 may be slid up and down within the main cylindrical housing 243, and the overall dimensions for the syringe are approximately 4″ in length and 1″ in diameter. The plunger 242 is preferably not removable from the housing 243. The syringe may have marks 244 resembling those of a real syringe. The syringe may be modified slightly to simulate the look of an insulin syringe for use with the insulin version of the doll. The syringe may also contain a microchip (not shown) as part of the passively coupled RF system such that the doll will “recognize” the object when it is in close proximity to the body cavity RF sensor and respond with the audible phrase specifically for this piece of equipment.

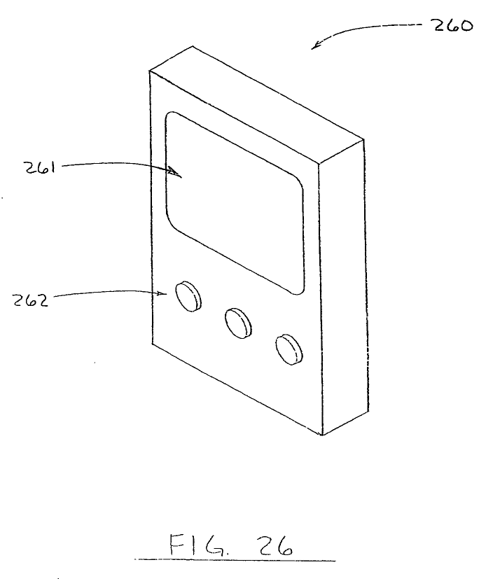

FIG. 25 illustrates a knapsack 250 of the present invention, which can be utilized to store and transport the doll and pseudo-medical equipment of the present invention. The knapsack can be any size suitable to carry the doll, pseudo-medical equipment, and book. In one embodiment, the knapsack is approximately 16-18″ in height, 12″ in width, and 6″ deep. The knapsack 250 may be made of any appropriate soft, flexible, and durable material. In one embodiment, the knapsack is made from cloth or plastic, and utilizes bright colors, which are appealing to children. The knapsack may include one or more pockets 251, which may be labeled with a symbol 252 to allow the child to identify which item of the invention goes in each pocket. In another embodiment, the pockets have an opening at the top which can be closed using any fastener known in the art, including but not limited to Velcro™, snaps, buttons, zippers, or hooks. The knapsack may contain one or more adjustable straps 253 to allow the child to easily carry the knapsack 250.

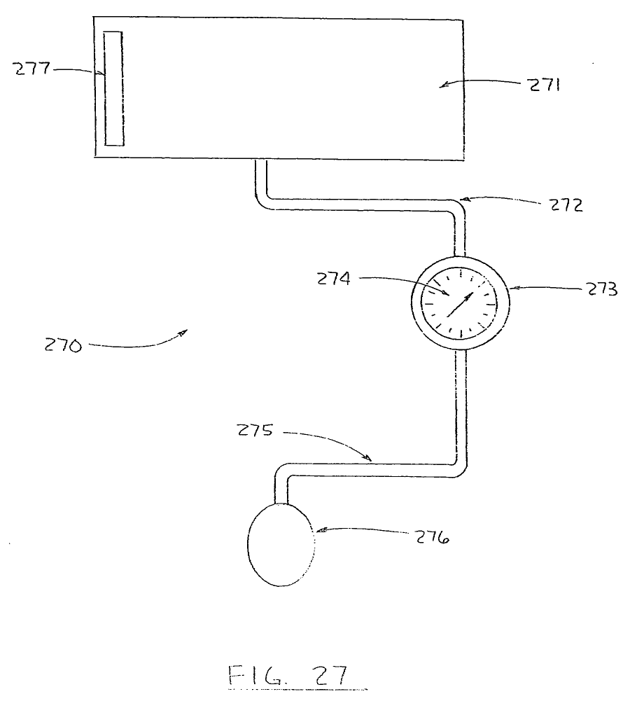

FIG. 26 depicts a glucose monitor 260 that may comprise part of a diabetes pseudo-medical equipment kit. The glucose monitor 260 is of a size compatible with use by a child to simulate treatment of the doll. In one embodiment, the glucose monitor 260 is approximately 4″ in length 2.5 inches in width and 1″ thick, and is made from a polymeric material. In one embodiment, a decal is utilized to depict a display screen 261 on the glucose monitor 260 and has push buttons 262 to simulate buttons that would be pushed on a real monitor to obtain readings. In another embodiment, the screen is an actual LCD or other type of display screen 263. The buttons 262 produce random displays on the display screen 261 similar to those that would be seen on a real screen during blood sampling. The unit may be powered by an internal battery source (not shown) to produce the display screens. A small microchip (not shown) can be connected to the buttons 262, display screen 261, and battery (not shown) in a standard electrical wiring format known to those skilled in the art, to provide the desired display screen 261 visual effect when buttons 262 are pushed. In a more advanced embodiment, the display screen corresponds to scenarios depicted in an accompanying book, or interfaces with the doll's microprocessor to run scenarios which correspond to audio responses from the doll. The toy glucose meter 260 may also contain a microchip (not shown) as part of the passively coupled RF system such that the doll will “recognize” the object when it is in close proximity to the body cavity RF sensor and respond with audible phrases which correspond to this piece of equipment.

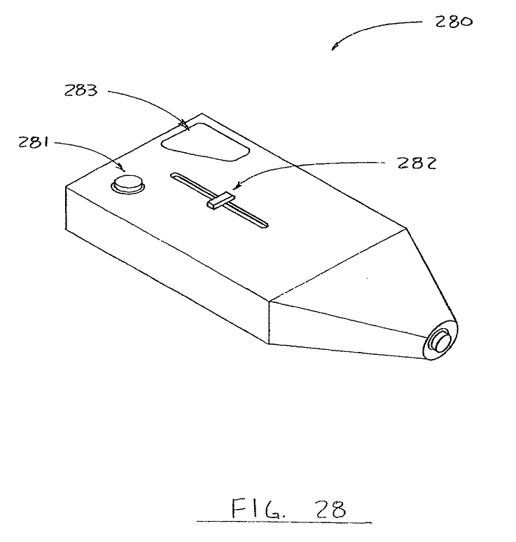

FIG. 27 depicts a toy blood pressure cuff 270 that may comprise part of a diabetes pseudo-medical equipment kit. The toy blood pressure cuff 270 resembles a real blood pressure cuff used in a doctor's office, and is of a size compatible for use by a child to simulate treatment of the doll. In one embodiment, the blood pressure cuff 270 arm band 271 is approximately 12″ in length, and 2.5″ wide, and in composed of two layers of soft fabric or other suitable material. A Velcro™ strip 277 positioned across the width of one end of the blood pressure cuff 270 allows the child to wrap the arm band 271 around the doll's arm and fix it in place while taking a pretend reading. Sandwiched between the two fabric layers is an air bladder (not shown) composed of a polymeric or other suitable material. In a preferred embodiment, the air bladder (not shown) is approximately 8″ in length, and 1″ wide. One end of a length of flexible rubber, or other suitable material, tubing 272 approximately 5″ long joins with the air bladder inside the arm band 271. The opposite end of the tubing joins to a dial gauge 273. The dial gauge is preferably approximately 2.5″ in diameter and 1″ in depth. The dial gauge contains an internal rod (not shown) mounted across the width at the center of the circular shape. Attached to one end of the rod is a cylinder (not shown). From the cylinder several cupped veins (not shown) protrude that allow the cylinder to be turned when air is forced into the dial gauge 273. One end of the rod connects to the dial needle 274, causing the needle to spin when the cylinder rotates. It is preferable that the cylinder be mounted and provide some resistance such that the needle 274 does not spin too rapidly. The simulation of needle 274 movement is well known to those skilled in the art and is in use in children's toys today. For this reason, details of the internal mechanism to cause the needle 274 to spin, are not shown in the Figure or described here in excessive detail. Any known method may be used to simulate the needle 274 movement. A second length of rubber, or other suitable material, tubing 275, preferably approximately 6″, long joins to the dial gauge 273 on the side opposing the entry of the first rubber tube 272. The opposite end of the rubber tube 275, joins to a rubber, or other suitable material hollow bulb 276 of a 3-dimensional oval shape of approximately 3″ length and 8″ in length circumference, and 2″ in width and 5.5″ in width circumference. When compressed, the hollow bulb 276 forces air through the rubber tube 275 and into the dial gauge 273, causing the needle 274 to rotate, and the air bladder to fill with air to simulate the use of a real blood pressure cuff.

In another embodiment, the needle 274 may be fixed with no internal drive mechanism required. In another embodiment, the needle 274 drive mechanism may stop the needle at a specific reading or otherwise mimic the motion of a gauge needle during a real blood pressure reading. The joining of the rubber tubes 272, 275 to the air bladder, arm band 271, dial gauge 273 and hollow bulb 276 may be any method known to those skilled in the art. The toy blood pressure cuff 270 may also contain a microchip (not shown) as part of the passively coupled RF system such that the doll will “recognize” the object when it is in close proximity to the body cavity RF sensor and respond with audible phrases which correspond to this piece of equipment.

FIG. 28 depicts a toy lancet 280 that may comprise part of a diabetes pseudo-medical equipment kit. In one embodiment, the lancet 280 is shaped like a rectangular box with a pointed, blunt end. This end is where the lancet 280 would normally be held against the body and where the razor to prick the skin would emit from in a real medical lancet. The dimensions are approximately 3.5″ in total length, 1.5″ in total width and 0.5″ in height. It also has a decal 283 for any desired labeling. The lancet 280 in this embodiment also has a button 281 that may be depressed by the child to simulate the clicking noise of a real lancet, and a bar 282 that slides as the clicking noise is heard. The bar 282 is attached to a tension spring (not shown). As the bar 282 is pulled away from the pointed end of the lancet 280, the spring is placed under tension. When pulled far enough, the bar 282 locks into a fixed position with the spring under tension, until the button 281 is depressed, releasing the lock, and allowing the bar to slide quickly toward the pointed end of the lancet 280. Standard methods known to those skilled in the art may be used to cause the sliding of the bar 282, such as those used in the operation of a toy gun where a lever is cocked into a spring loaded position and then released when the gun's trigger is depressed, causing the lever to spring forward and make a noise when it strikes a surface. The toy lancet 280 may also contain a microchip (not shown) as part of the passively coupled RF system such that the doll will “recognize” the object when it is in close proximity to the body cavity RF sensor and respond with audible phrases which correspond to this piece of equipment.

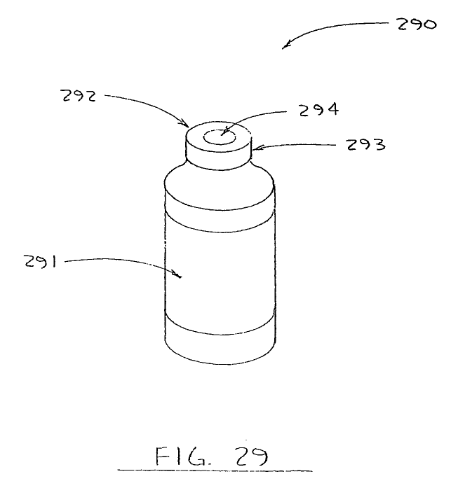

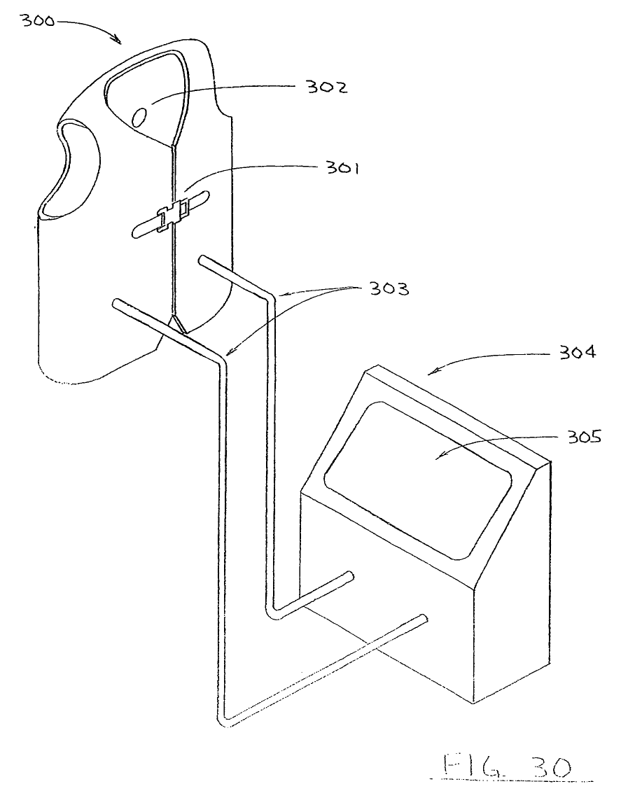

FIG. 29 depicts a toy insulin vial 290 that may comprise part of a diabetes pseudo-medical equipment kit. In one embodiment, the vial is 2.5″ in height, with a base 3.5″ in diameter and top portion 2.5″ in diameter. The vial 290 may be made of a polymeric or any other suitable material. A decal 291 may be provided to affix to the outer cylinder of the base of the vial 290 and resemble a colorful version of a standard prescription on instruction sticker. The vial 290 has a cap 292 covering the vertical surface of the top portion. The cap 292 may be a permanent part of the vial 290 (not removable), and may be comprised of the same material as the vial 290. The cap 292 may be comprised of two colors, one for an outer ring 293 and one for an inner ring 294, to simulate an inner area where a needle would normally be inserted to withdraw fluid from within the vial 290. The toy insulin vial 290 may also contain a microchip (not shown) as part of the passively coupled RF system such that the doll will “recognize” the object when it is in close proximity to the body cavity RF sensor and respond with audible phrases which correspond to this piece of equipment.

FIG. 30 depicts a toy cystic fibrosis vest 300 that may comprise part of a cystic fibrosis pseudo-medical equipment kit. In one embodiment, the vest 300 resembles a child's water safety vest with a v-shaped neckline and no sleeves. The vest 300 is approximately sized for use with the doll. The vest 300 may be made of heavy-duty nylon, canvas or any other suitable material, and preferably includes one or more plastic buckles 301 on the front chest to secure the vest around the doll. The vest includes a plastic snap 302 with metal center prong on the inner side of the vest at the center of the back of the neck. This snap 302 is placed into a corresponding receptacle at the base of the neck on the upper back of the cystic fibrosis version of the doll. Two tubes 303 connect to the front of the vest on the right and left sides of the lower rib cage area. The tubes 303 may be composed of flexible plastic, or any other suitable material, and are scaled appropriately for the doll and vest. Preferably, the tubes are approximately 15″ in length and 1″ in diameter. The opposite ends of both tubes 303 connect to a power unit 304. The power unit 304 may be made of plastic or any other suitable material. It may contain a decal 305 for labeling, and is approximately.

To simulate the effects that a child feels when using a real medical vest, the cystic fibrosis version of the chronic illness doll contains a motor (not shown) in the doll's central body cavity, which will cause the doll to shake when activated. To trigger the shaking, the vest 300 must be snapped to the doll at the back of the neck, this completes an electrical circuit confirming that the vest 300 has been placed on the doll. The cystic fibrosis version of the doll, in this embodiment, also contains a contact sensor (not shown) in the left hand of similar design as the contact sensor 50 (see FIG. 4) in the right hand. Once the vest 300 is snapped into place, the depression of the doll's left hand will cause the doll to shake for a specific number of seconds. A vibratory motor (not shown) or other means used to produce the shaking can use any means known to those skilled the state of the art. In another embodiment, a button (not shown) on the power unit 304 or on the vest 300 itself may be depressed to begin the shaking motion. Any electrical circuitry required within the doll or within the vest 300, tubes 303 and power unit 304 to relay a signal between the contact sensor to the doll's microprocessor 44 (see FIG. 4) can be selected by one skilled in the art without undue experimentation.

In another embodiment, the vest may be designed to inflate a layer of air to further simulate the performance of a real medical vest, with the source of air being external, or designed to emanating from either the doll or the power unit 304. The vest 300 may also contain a microchip (not shown) as part of the passively coupled RF system such that the doll will “recognize” the vest when it is in close proximity to the body cavity RF sensor and respond with the audible phrase specifically for this piece of equipment. The complexity of the mechanics of the vest may be decreased to reduce production costs, or increased to produce a more realistic simulation as a manufacturer skilled in the art may desire.

We claim:

1. An interactive toy for use in learning about chronic illnesses comprising: a doll having an inner and outer surface, an internal proximity switch; one or more internal electrical wires connecting said internal proximity switch to an internal microprocessor; and an audio speaker connected to said internal microprocessor, wherein upon activation of the microprocessor, said doll produces a programmed response.

2. The toy of claim 1, wherein said programmed response is representative of a chronic illness.

3. The toy of claim 2, wherein said chronic illness is selected from the group consisting of: asthma, allergies, cystic fibrosis, and diabetes.

4. The toy of claim 1, wherein said programmed response is selected from the group consisting of: coughing sounds, wheezing sounds, speech, heart sounds, bowel sounds, breathing, lung sounds, audible sound, heat emission, light emission, and motion.

5. The toy of claim 1, further comprising pseudo-medical equipment having an activator which closes said internal proximity switch when brought into proximity with the doll, thereby completing an internal electrical circuit between said internal proximity switch and said internal microprocessor.

6. The toy of claim 5, wherein said activator comprises a magnet.

7. The toy of claim 5, wherein said pseudo-medical equipment is selected from the group consisting of: a medicine dropper bottle, a nose sprayer, a syringe, a simulated patient chart, a stethoscope, a peak flow meter, an inhaler, a nebulizer, a glucose meter, a lancet, a insulin syringe, a blood pressure cuff, feeding and intravenous lines, a medicine bottle, a nose sprayer, a medical bracelet, an eye dropper, and a cystic fibrosis vest.

8. The toy of claim 1, further comprising a book containing text, wherein the text of said book is programmed into said microprocessor such that upon activation of said microprocessor, said doll produces audible sound corresponding to the text of said book.

9. An interactive toy for use in learning about chronic illnesses comprising: a doll having an inner and outer surface, an internal radio receiver, one or more internal electrical wires connecting said internal radio receiver to an internal microprocessor; and an audio speaker connected to said internal microprocessor, such that upon receipt of a radio signal by said internal radio receiver, said signal is processed by said microprocessor to generate a programmed response.

10. The toy of claim 9, wherein said programmed response is representative of a chronic illness.

11. The toy of claim 10, wherein said chronic illness is selected from the group consisting of: asthma, allergies, cystic fibrosis, and diabetes.

12. The toy of claim 9 wherein said programmed response is selected from the group consisting of: coughing sounds, wheezing sounds, speech, heart sounds, bowel sounds, breathing, and lung sounds, audible sound, heat emission, light emission, and motion.

13. The toy of claim 9 further comprising pseudo-medical equipment having means for emitting radio signals, whereby said radio receiver scans for said signals, receives said signals, and activates said microprocessor to generate a programmed response.

14. The toy of claim 13, wherein each unique item of said pseudo-medical equipment emits a unique radio signal such that, upon receipt of said signal by said internal radio receiver, said unique item is individually recognized by said internal microprocessor to generate a unique programmed response.

15. The toy of claim 13, wherein said pseudo-medical equipment is selected from the group consisting of: a medicine dropper bottle, a nose sprayer, a syringe, a simulated patient chart, a stethoscope, a peak flow meter, an inhaler, a nebulizer, a glucose meter, a lancet, a insulin syringe, a blood pressure cuff, feeding and intravenous lines, a medicine bottle, a nose sprayer, a medical bracelet, a story book, an eye dropper, and a cystic fibrosis vest.

16. The toy of claim 9, wherein said doll further comprises an internal proximity switch which correlates to an activator located within said item of pseudo-medical equipment, such that bringing said activator into proximity with said internal proximity switch closes said internal proximity switch, thereby completing an internal electrical circuit between said internal proximity switch and said internal microprocessor.

17. A kit for educating a user about chronic illness and treatment and management of an illness, comprising
(a) a doll having an inner and outer surface, an internal proximity switch; one or more internal electrical wires connecting said internal proximity switch to an internal microprocessor; and an audio speaker connected to said internal microprocessor, wherein upon activation of said microprocessor, said doll produces a programmed response;
(b) pseudo-medical equipment; and
(c) a knapsack for storing and carrying said doll and said pseudo-medical equipment.

18. The kit of claim 17, wherein said pseudo-medical equipment comprises an activator which closes said internal proximity switch when brought into proximity of the doll thereby completing an internal electrical circuit between said internal proximity switch and said internal microprocessor.

19. The kit of claim 17, wherein said pseudo-medical equipment is selected from the group consisting of a medicine dropper bottle, a nose sprayer, a syringe, a simulated patient chart, a stethoscope, a peak flow meter, an inhaler, a nebulizer, a glucose meter, a lancet, a insulin syringe, a blood pressure cuff, feeding and intravenous lines, a medicine bottle, a nose sprayer, a medical bracelet, a story book, an eye dropper, and a cystic fibrosis vest.

20. The kit of claim 17, further comprising a book, wherein the text of said book are programmed into said doll, and wherein upon activation of said doll, said doll produces audible sound corresponding to the text of said book.
